(19) United States
(12) Patent Application Publication
(10) Pub. No.: US 2026/0145239 A1
(43) Pub. Date: May 28, 2026

(54) METHOD AND DEVICE FOR LASER BUILD-UP WELDING WITH VARIABLE LAYER THICKNESS

(71) Applicant: TRUMPF Laser- und Systemtechnik SE, Ditzingen (DE)

(72) Inventors: Bjoern Sautter, Leonberg (DE); Tim Hesse, Ditzingen (DE); Andreas Scholz, Taunusstein (DE)

(21) Appl. No.: 19/448,164

(22) Filed: Jan. 14, 2026

Related U.S. Application Data
(63) Continuation of application No. PCT/EP2024/070168, filed on Jul. 16, 2024.

(30) Foreign Application Priority Data
Jul. 21, 2023 (DE) 10 2023 119 380.5

(51) Int. Cl. B22F 10/37; B22F 10/36; B22F 10/85; B22F 12/00; B22F 12/41; B22F 12/57; B33Y 10/00; B33Y 30/00; B33Y 50/02

(52) U.S. Cl. CPC B22F 10/37; B22F 10/36; B22F 10/85; B22F 12/226; B22F 12/41; B22F 12/57; B33Y 10/00; B33Y 30/00; B33Y 50/02

(57) ABSTRACT

A method for laser deposition welding in a laser system includes actuating a processing unit having a jet nozzle for providing a laser beam and a powder jet so that the powder jet, in interaction with the laser beam, deposits a powder-layer trace onto a workpiece, actuating a workpiece receiving unit, on which the workpiece is arranged, so that a rotational movement moves the workpiece about an axis of rotation, and actuating a translation unit so that a translational movement moves the jet nozzle and/or the workpiece receiving unit in an offset direction orthogonal to the axis of rotation. The rotational movement and the translational movement combine to form an advancing movement such that the powder-layer trace is deposited onto the workpiece along a spiral path. A processing parameter varies as processing of the workpiece progresses so that a powder layer thickness varies along a radial direction of the workpiece.

### CROSS REFERENCE TO RELATED APPLICATIONS

This application is a continuation of International Application No. PCT/EP2024/070168 (WO 2025/021597A1 ), filed on Jul. 16, 2024, and claims benefit to German Patent Application No. DE 10 2023 119 380.5, filed on Jul. 21, 2023. The aforementioned applications are hereby incorporated by reference herein.

### FIELD

Embodiments of the present invention relate to a method for laser deposition welding in a laser system and to a control unit for use in a laser system.

### BACKGROUND

Laser deposition welding is used in the fields of repair, coating and joining technology, for example. A distinction may be drawn between conventional laser deposition welding techniques (laser metal deposition (LMD), direct metal deposition (DMD) or direct energy deposition (DED)), and “high-speed laser metal deposition” (HS-LMD or extreme high-speed laser application (EHLA)). HS-LMD methods are described, for example, in DE 10 2011 100 456 B4 or in DE 10 2018 130 798 A1. An unavoidable side effect of laser deposition welding is distortion of the processed workpiece due to thermal input, which results in internal stresses in the processed workpiece during laser deposition welding, bringing about distortion during a cooling phase following the laser deposition welding process. The distortion brings about concave or convex curvature of the component. In order for functional surfaces deposited on the workpiece by means of laser deposition welding to display a flat, non-curved surface for their intended use despite distortion, grinding of the functional surfaces is required after the cooling phase.

### SUMMARY

Embodiments of the present invention provide a method for laser deposition welding in a laser system. The method includes actuating a processing unit having a multifunctional jet nozzle for providing a laser beam and a powder jet, so that the powder jet, in interaction with the laser beam, deposits a powder-layer trace onto a workpiece, actuating a workpiece receiving unit, on which the workpiece is arranged, so that a rotational movement moves the workpiece about an axis of rotation, and actuating a translation unit so that a translational movement moves the jet nozzle and/or the workpiece receiving unit in an offset direction substantially orthogonal to the axis of rotation. The rotational movement and the translational movement combine to form an advancing movement such that the powder-layer trace is deposited onto the workpiece along a spiral path. A processing parameter varies as processing of the workpiece progresses so that a powder layer thickness varies along a radial direction of the workpiece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a laser system according to some embodiments;

FIG. 2a, FIG. 2b, FIG. 2c, and FIG. 2d show exemplary intensity distributions of a laser beam according to some embodiments;

FIG. 3 shows a spiral path, along which a powder-layer trace is deposited onto a workpiece according to some embodiments;

FIG. 4 shows a schematic view of adjacent powder-layer traces according to some embodiments; and

FIG. 5 shows a schematic view of a workpiece processed on both sides according to some embodiments.

### DETAILED DESCRIPTION

Embodiments of the present invention provide an improved method for laser deposition welding and a corresponding device. In particular, embodiments of the present invention can efficiently compensate for the side effects of thermal distortion. It is further desirable to ensure a low level of material abrasion during laser deposition welding.

Accordingly, a method for laser deposition welding in a laser system is proposed. The laser system may have a laser source for generating a laser beam with a wavelength in the range between 0.4 μm and 1.5 μm. The laser source may be a disk laser, a fiber laser, or a diode laser. In this way, for example, laser beams with wavelengths of around 450 nm, of around 515 nm, between around 800 nm and around 1000 nm, or of around 1030 nm, 1060 nm or 1070 nm may be generated. The laser beam may be arranged such that it may be guided to a processing head by means of an optical fiber. The laser source may have a laser power of between 2 kW and 24 kW. If a workpiece being treated using the method is a brake disk, the laser power may in particular be between 8 kW and 24 kW, whereas if it is a plain bearing, the laser power may in particular be 2 kW. The laser power may be constant during processing or vary depending on the stage of the method.

The method includes the step of actuating a processing unit having a multifunctional jet nozzle for providing a laser beam and a powder jet, such that the powder jet, in interaction with the laser beam, deposits a powder-layer trace onto an in particular rotationally symmetrical workpiece, such as a brake disk, a hydraulic cylinder, a pressure roller or a plain bearing. Actuation may take place between a central control unit of the laser system and a local control unit of the processing unit. The jet nozzle is provided to orient the laser beam and the powder jet onto the workpiece. The powder jet may contain a pulverulent material including hard-material particles, in particular carbides, which do not dissolve after interaction with the laser beam in an interaction zone. The laser beam may be directed substantially orthogonally onto a surface to be processed of the workpiece. The powder jet may be inclined in relation to the laser beam in order to form an interaction zone between the powder jet and the laser beam above the material surface. Such an interaction zone enables more efficient deposition of the pulverulent material onto the workpiece. The laser beam exiting from the jet nozzle may have a reduced core intensity in a core region in comparison with an edge region. For example, the core intensity may be less than 90% of the edge intensity. Thus, at least within the interaction zone, the laser beam has an intensity in an edge region which is higher than a core intensity of the laser beam, such that the pulverulent material is exposed to the higher intensity of the edge region on entry into the interaction zone.

The method further includes the step of actuating a workpiece receiving unit, on which the workpiece is arranged, with the result that a rotational movement moves the workpiece about an axis of rotation. Actuation may take place between the central control unit of the laser system and a local control unit of the workpiece receiving unit. The workpiece receiving unit may clamp the workpiece such that it is firmly mounted therein, provided that the workpiece receiving unit is itself rotatable. The axis of rotation may correspond to an axis of rotational symmetry of the rotationally symmetrical workpiece. The jet nozzle may be directed at a location on the workpiece that lies radially outside the axis of rotational symmetry thereof. Thus, rotation about the axis of rotation causes the powder-layer trace to follow a path on the workpiece. Rotational movement of the workpiece receiving unit may be initiated by an independent drive.

The method further includes the step of actuating a translation unit, with the result that a translational movement moves the jet nozzle and/or the workpiece receiving unit in an offset direction substantially orthogonal to the axis of rotation. Actuation may take place between the central control unit of the laser system and a local control unit of the translation unit. The translational movement may be initiated by a drive that is separate from the workpiece receiving unit. Alternatively, the translational movement may be initiated by the same drive as the rotational movement. The orthogonal offset direction of the translational movement brings about translation orthogonal to the axis of rotation, which may accordingly have an effect on a path of the powder-layer trace. The rotational movement may be very significant compared to the translational movement.

The rotational movement and the translational movement combine to form an advancing movement, such that the powder-layer trace is deposited onto the workpiece along a spiral path. This enables extensive powder coating in a radial direction of the workpiece. The geometric shape of the spiral path is determined by the advancing movement. The advancing movement may influence process parameters, such as for example the duration of action between powder jet, laser beam and workpiece, to enable robust bonding of the pulverulent particles with the workpiece. The spiral path extends along a curve about the axis of rotation, with the distance from the axis of rotation increasing if deposition proceeds from radially inside to radially outside, or decreasing if deposition proceeds from radially outside to radially inside. The rotational movement has a rotational speed, while the translational movement has a translational speed. If the processing parameter is the advancing movement, variation results from a variation in rotational and/or translational speed.

A processing parameter varies as the processing of the workpiece progresses, with the result that a powder layer thickness varies along a radial direction of the workpiece. Thus, optimized processing may be ensured due to the correlation between the powder layer thickness and a processing parameter such as advancing movement, powder mass flow of the powder jet and/or laser power. To adjust the powder layer thickness, the processing parameter is varied accordingly. The processing parameter may be varied identically for each component. Alternatively, variation of the processing parameter is dependent on how the workpiece behaves during laser deposition welding. For this purpose, a measuring system may send a control signal to the translation unit and/or the workpiece receiving unit. The method makes variable adjustment of powder layer thickness possible. Target geometries for the workpiece and/or powder layer thickness may be taken into account, as well as process parameters and their consequences, such as distortion of the workpiece. The thermal input during laser deposition welding leads to internal stresses and distortion of the workpiece, which may be compensated or mitigated by varying the processing parameter in such a way that the deposited layer is substantially flat, i.e., not curved, or at least is less curved than if the processing parameters are kept constant as processing progresses. This minimizes or reduces material removal resulting from grinding of the deposited layer, thus enabling more efficient processing and lower material costs.

In one embodiment, the processing parameter is the advancing movement, a powder mass flow rate of the powder jet and/or a laser power by which the laser beam is provided. The deposited powder layer thickness may be reliably varied by varying one of these parameters or a combination thereof. This contributes efficiently to compensating thermal distortion.

In one embodiment, the powder-layer trace has a radial trace width, wherein an offset between two adjacent spiral flanks of the spiral path is less than the trace width, such that the powder-layer trace forms a radial overlap along the spiral path. Thus, when depositing from radially inside to radially outside, one radially inner powder-layer trace is arranged under the next radially outer powder-layer trace. Accordingly, when depositing from radially outside to radially inside, one radially outer powder-layer trace is arranged under the next radially inner powder-layer trace. This radial overlap increases the powder layer thickness because at least partially overlaid powder-layer traces, i.e., overlapping powder-layer traces, have a greater powder layer thickness than two powder-layer traces whose offset is greater than their radial trace width.

In one embodiment, the radial overlap varies proportionally to the varying advancing movement. This means that the radial trace width remains unaffected by the advancing movement, resulting in an efficient manner of controlling radial overlap. The greater the advancing movement, the greater the radial overlap. If, for example, a distortion of the workpiece due to thermal input is known in advance, a precise and process-compliant adjustment of the powder layer thickness may accordingly be achieved via control of the advancing movement, such that the varying powder layer thickness compensates for the distortion.

In one embodiment, a rate of the advancing movement, i.e., the rate of advance, increases, in particular linearly or progressively, during processing of a first workpiece side from a radially inner workpiece portion to a radially outer workpiece portion, as the processing progresses, such that the radial overlap of the spiral path at the radially outer portion is less than at the radially inner portion. Alternatively, the rate of advance decreases, in particular linearly or degressively, during processing of the first workpiece side from a radially outer workpiece portion to a radially inner workpiece portion, as the processing progresses, such that the radial overlap of the spiral path at the radially outer portion is less than at the radially inner portion. This ensures that the powder layer thickness is less at the radially outer portion than at the radially inner portion. This may counteract convex distortion of the workpiece. Therefore, if the distortion is such that the radially outer portion protrudes further in the direction of the powder layer thickness, adjusting the advancing movement may compensate for the distortion at least in part.

In one embodiment, the rate of advance decreases, in particular linearly or degressively, during processing of a second workpiece side, which differs in particular from the first workpiece side, from a radially inner workpiece portion to a radially outer workpiece portion as the processing progresses, such that the radial overlap of the spiral path is greater at the radially outer portion than at the radially inner portion. Alternatively, the rate of advance increases, in particular linearly or progressively, during processing of the second workpiece side from a radially outer workpiece portion to a radially inner workpiece portion, as the processing progresses, such that the radial overlap of the spiral path is greater at the radially outer portion than at the radially inner portion. This may counteract concave distortion of the workpiece. Therefore, if the distortion is such that the radially outer portion is curved contrary to the direction of the powder layer thickness, adjusting the advancing movement may compensate the distortion at least in part. The two embodiments in which convex distortion and concave distortion are counteracted may be combined in particular in a workpiece where the top side is the first workpiece side and the bottom side is the second workpiece side. If the radially outer portion of the first workpiece side distorts upward, this causes the radially outer portion of the second workpiece side to curve. While a radially outwardly decreasing powder layer thickness may be deposited on the first workpiece side, a complementary, radially increasing powder layer thickness may be deposited on the second workpiece side in order to compensate for the distortion. This extends the advantages of the method to workpieces processed on both sides.

In one embodiment, depending on a distortion that occurs in the workpiece during laser deposition welding, it is determined whether a workpiece side is processed as the first workpiece side or as the second workpiece side. Thus, depending on the individual distortion, the corresponding powder layer thickness may be adjusted to the corresponding workpiece side, so further contributing to a reduction in material costs.

In one embodiment, the radial overlap of the powder-layer trace at a first radial end portion, for instance a radially inner workpiece portion or a radially outer workpiece portion, amounts to above 50%, in particular 70% to 80%, of the trace width, and at a second radial end portion, for instance the radially outer workpiece portion or the radially inner workpiece portion, it amounts to below 50%, in particular 20% to 40%, of the trace width. If the radial overlap of the powder-layer trace amounts, for example, to 70% to 80%, this means that 70% to 80% of the one powder-layer trace is lying over the other, adjacent, previously deposited powder-layer trace. If, accordingly, the radial overlap of the powder-layer trace amounts to between 20% and 40%, this means that only 20% to 40% of the one powder-layer trace is lying over the other, adjacent, previously deposited powder-layer trace. Whether the one or the other powder-layer trace is the radially inner or radially outer powder-layer trace depends on whether deposition proceeds from radially inside to radially outside or from radially outside to radially inside. The smaller the radial overlap, the smaller the powder layer thickness.

In one embodiment, the radial overlap of the powder-layer trace at a first radial end portion, for instance a radially inner workpiece portion or a radially outer workpiece portion, results in a first layer thickness, and at a second radial end portion, for instance the radially outer workpiece portion or the radially inner workpiece portion, it results in a second layer thickness, wherein the first layer thickness exceeds the second layer thickness by a factor of 1.5 or more, in particular 2 or 2.5. Thus, the powder layer thickness may vary along the radial direction in such a way that it is, for example, more than twice as great at one end portion as at the other end portion. This allows for a large variance in powder layer thickness and, accordingly, the compensation of significant workpiece distortions.

In one embodiment, the varying processing parameter, in particular the varying advancing movement, is preset in response to previously processed workpieces. This allows the distortion of processed workpieces caused by laser deposition welding to be determined and evaluated, and used as an input parameter for the advancing movement. For example, statistical evaluation modules or neural networks may be used to evaluate previously processed workpieces. This allows for precise adjustment of the powder layer thickness to the expected distortion of the workpiece.

In one embodiment, rotational movement is constant, such that the varying advancing movement results exclusively from the varying translational movement. The rotational movement of the workpiece receiving unit may have a greater influence on the process parameters than the translational movement. In this respect, translational movement may be used as the sole influencing factor for variation of the advancing movement. This further contributes to efficient workpiece processing. For the purposes of this disclosure, a constant movement may in particular be a movement at constant speed. A varying movement may accordingly be, in particular, a movement at varying speed.

In one embodiment, the workpiece is arranged fixed in the offset direction, such that the translational movement results from the movement of the jet nozzle. The workpiece is arranged to be rotatable in the direction of rotation. This results in an efficient separation of functions, in that rotational movement is used to vary process-relevant parameters and translational movement is used to vary powder layer thickness. Translational movement of the jet nozzle may be implemented by driving the laser system in the advance direction. By separating the functions, the highest quality standards may be combined with minimal processing times.

In one embodiment, the powder-layer trace forms an adhesive layer onto which an abrasion-resistant layer is deposited in a next step. In this way, the method results in a component being coated with two layers. The adhesive layer serves in particular to improve the adhesive properties of the deposited trace. The abrasion-resistant layer increases the load-bearing capacity of the workpiece. With the abrasion-resistant layer, the processing parameter, especially the advancing movement, may vary as the processing progresses or alternatively remain constant. Alternatively, if the component has only a single coating layer, the powder-layer trace is an abrasion-resistant layer.

The disclosure further relates to a control unit for use in a laser system for laser deposition welding, wherein the control unit is provided and configured to carry out the method as disclosed. The control unit may be part of a central control unit of the laser system or a standalone, local control unit. The effects and advantages disclosed in connection with the method extend accordingly to the control unit.

The disclosure further relates to a laser system for laser deposition welding. The laser system has a processing unit with a multifunctional jet nozzle for providing a laser beam and a powder jet. The jet nozzle is provided to orient the laser beam and the powder jet onto a workpiece. The powder jet may contain a pulverulent material including hard-material particles, in particular carbides, which do not dissolve after interaction with the laser beam in an interaction zone. The laser beam may be directed substantially orthogonally onto a surface to be processed of the workpiece. The powder jet may be inclined in relation to the laser beam in order to form an interaction zone between the powder jet and the laser beam above the material surface. Such an interaction zone enables more efficient deposition of the pulverulent material onto the workpiece. The laser beam exiting from the jet nozzle may have a reduced core intensity in a core region in comparison with an edge region. For example, the core intensity may be less than 90% of the edge intensity. Thus, at least within the interaction zone, the laser beam has an intensity in an edge region which is higher than a core intensity of the laser beam, such that the pulverulent material is exposed to the higher intensity of the edge region on entry into the interaction zone.

The laser system also has a workpiece receiving unit, on which a workpiece is arranged. The workpiece receiving unit may clamp the workpiece such that it is firmly mounted therein, provided that the workpiece receiving unit is itself rotatable. The axis of rotation may correspond to an axis of rotational symmetry of the rotationally symmetrical workpiece. Rotational movement of the workpiece receiving unit may be initiated by an independent drive. The workpiece may be rotationally symmetrical, in particular it is a brake disk, a hydraulic cylinder, a pressure roller or a plain bearing.

The laser system also has a translation unit configured to move the jet nozzle and/or the workpiece receiving unit in an offset direction substantially orthogonal to the axis of rotation. The translational movement may be initiated by a drive that is separate from the workpiece receiving unit. Alternatively, the translational movement may be initiated by the same drive as the rotational movement. The orthogonal offset direction of the translational movement brings about translation orthogonal to the axis of rotation, which may accordingly have an effect on a path of the powder-layer trace. The rotational movement may be very significant compared to the translational movement.

The laser system also has a control unit as disclosed above. This is configured and provided to carry out the method for laser deposition welding.

Preferred exemplary embodiments are described below with reference to the figures. In this respect, elements that are the same, similar, or have the same effect are provided with identical reference signs in the various figures, and a repeated description of these elements is omitted in some instances to avoid redundancies.

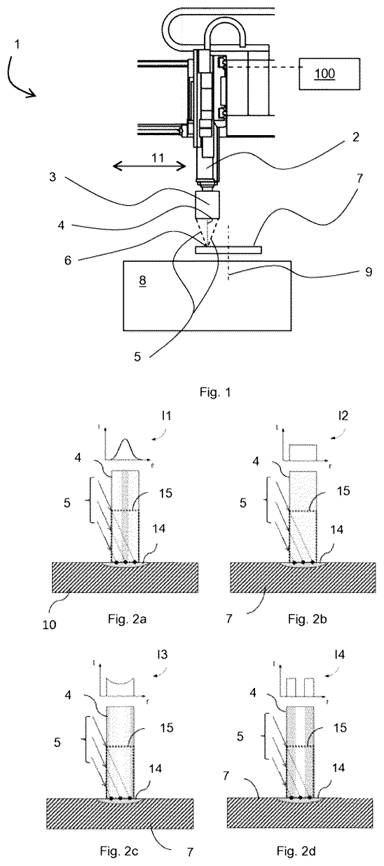

FIG. 1 shows a laser system 1 for laser deposition welding. In laser deposition welding, a powder layer is deposited onto a workpiece by melting a pulverulent material with a laser and materially bonding it to the workpiece. The laser system 1 has a control unit 100 that actuates the individual components of the laser system 1. A processing unit 2 is connected to a laser source (not shown). The laser source may be a disk laser, a fiber laser, or a diode laser. Laser beams having wavelengths of around 450 nm, of around 515 nm, between around 800 nm and around 1000 nm, or of around 1030 nm, 1060 nm or 1070 nm may be generated, for example. The laser generated by the laser source may be arranged in such a way that it may be guided to a processing head of the processing unit 2, inter alia by means of an optical fiber. The laser source may have a laser power of between 2 kW and 24 kW. The processing head has a multifunctional jet nozzle 3 which orients on the one hand a laser beam 4 and on the other a powder jet 5 in a process-appropriate manner onto a powder-layer trace 6 of a rotationally symmetrical workpiece 7. The laser beam 4 may have a ring and a core component, as described in particular in connection with FIGS. 2a to 2d. It may be guided to processing unit 2 via a multi-clad fiber.

The workpiece 7 is arranged in a receiving unit 8 and rotates about an axis of rotation 9. A translational movement initiated by a translation unit 10 along the offset direction 11 is combined with the rotational movement, resulting in a spiral path 12 on the workpiece 7. Combining the rotational and translational movements results in the advancing movement with which the laser beam 4 and the powder jet 5 move relative to the workpiece 7. The advancing movement varies as the processing progresses. For example, it amounts to 20 m/s at the start of processing and then increases during the course of the process. Alternatively, it may decrease during the course of the process. Whether the advancing movement increases or decreases during the course of the process depends on how the workpiece distorts. For example, a top side may be processed with increasing advancing movement and a bottom side with decreasing advancing movement (see in particular further below in connection with FIG. 5).

The laser beam 4 may have a reduced intensity in a core area compared to a ring or edge area. For example, the core intensity may be less than 90% of the edge intensity. Thus, at least within the interaction zone between laser beam 4 and powder jet 5, the laser beam 4 has an intensity in an edge region which is higher than an intensity in the core region of the laser beam 4, such that the pulverulent material in the powder jet 5 is exposed to the higher intensity of the edge region on entry into the interaction zone. Due to the inclined orientation of the at least one powder jet 5 relative to the laser beam 4, the interaction section with the laser beam 4 varies over the cross-section of the powder jet 5. Due to the reduced intensity in the core region, a substantially homogeneous energy is supplied to the individual powder particles over a varying interaction section. In other words, an intensity maximum in the edge region of the laser beam leads to a more even distribution of the fluence per powder particle and thus to an enlargement of the process window together with stable welding quality.

The workpiece 7 may be a metallic workpiece. The pulverulent material may in particular comprise a metallic material. The pulverulent material may be delivered onto the workpiece surface by means of a carrier gas, in particular argon or helium, and/or by means of an inert gas mixture as a process shielding gas. The process shielding gas may additionally shield the processing location from the surrounding atmosphere. The focus of the laser beam 4 may be on the workpiece surface or directly above the workpiece surface. The jet nozzle 3 may have a ring opening for the laser beam 4 and one or more further openings for the powder jet 5. The ring opening may be configured in the manner of an annular gap nozzle or by means of multiple nozzles arranged annularly around the core opening in the manner of a multi-jet nozzle. The workpiece may, for example, be a brake disk, a hydraulic cylinder, a pressure roller, a plain bearing or another rotationally symmetrical workpiece.

FIGS. 2a to 2d show different intensity distributions of the laser beam 4, being schematic views of a sectional front view of a workpiece 7, which is locally melted by means of a laser beam 4 for the purposes of laser metal deposition, such that a weld pool 14 arises on the workpiece surface. While the laser beam 4 is being moved over the workpiece 7 perpendicularly to the plane of the drawing, a filler material in the form of a powder jet 5 is delivered to the processing point by means of a preferably inert carrier gas. For the sake of simplicity, FIGS. 2a-d each depict powder application from just one side. However, it goes without saying that, in the case of laser metal deposition, the filler material may be directed onto the processing point in multiple individual jets arranged annularly around the laser beam or in the form of a ring jet, and in the case of a linear beam profile of the laser beam for example from the front and/or from the rear in the form of a linear powder jet. Depending on the position of a powder particle within the powder jet 5, the interaction section within an interaction zone 15 along which a powder particle of the powder jet 5 interacts with the laser radiation and thus with the energy thereof varies in length. Accordingly, the powder particles are heated to different degrees by the laser beam 4, depending on their trajectory. While powder particles in the center of the powder jet 5 are melted within the interaction zone 15 for example, it is possible at the same time for powder particles in the edge region of the powder jet 5 to be evaporated owing to their longer or shorter interaction times with the laser beam 4 (cf. powder particles on the right or at the top in FIGS. 2a-d) or to impinge on the workpiece surface in the solid state (cf. powder particles on the left or at the bottom in FIGS. 2a-d). The temperature gradient of the powder particles during laser metal deposition is particularly great if the laser beam 4 has a Gaussian intensity profile I1 within the interaction zone 15. This case is illustrated in FIG. 2a. Powder particles at the outer (or bottom) edge of the powder jet 5 are heated particularly weakly. The non-uniform interaction time of the powder particles with the laser beam 4 may have a negative influence on the welding result. A high-quality weld bead may be ensured in a narrow process window with process parameters that are precisely matched to one another, in particular a precisely predetermined rotational movement. Even just changes to the laser power or rotational movement may lead to sensitive quality fluctuations in the welding result. An improvement in the temperature gradient and/or a narrower temperature bandwidth of the powder particles may be achieved if the laser beam 4 used has a flat-top or top hat-shaped intensity profile I2, as illustrated in FIG. 2b.

The powder may also be heated more uniformly if the laser beam 4 used has an intensity distribution I3, I4 according to FIG. 2c or 2d within the interaction zone 15. FIG. 2c depicts the laser beam 4 with a concave intensity profile I3 in the interaction zone 12, with the intensity dropping from an annular maximum toward the core region of the laser beam 4. Owing to the high intensity in the edge region of the laser beam 4, even powder particles having a short interaction time are still heated comparatively significantly. A particularly uniform temperature distribution of the powder particles may be achieved for a coaxial powder supply with an annular intensity profile of the laser beam 4 where the majority of the laser energy is present in the edge region of the laser beam 4. A flat-top or top hat-shaped intensity distribution I4 in the annular outer region of the laser beam 4 (cf. FIG. 2d) may be particularly advantageous. Use of the laser beam 4 with such an intensity distribution allows process stability to be influenced advantageously, in particular in the case of high-speed laser metal deposition. FIGS. 2c and 2d each relate to variants in which the laser beam 4 has a substantially rotationally symmetrical cross-section. It goes without saying that the depictions in FIGS. 2c and 2d may be applied mutatis mutandis to a laser beam 4 with a linear beam profile, wherein the respective intensity distribution I3, I4 is then present transversely of the length of the linear beam profile.

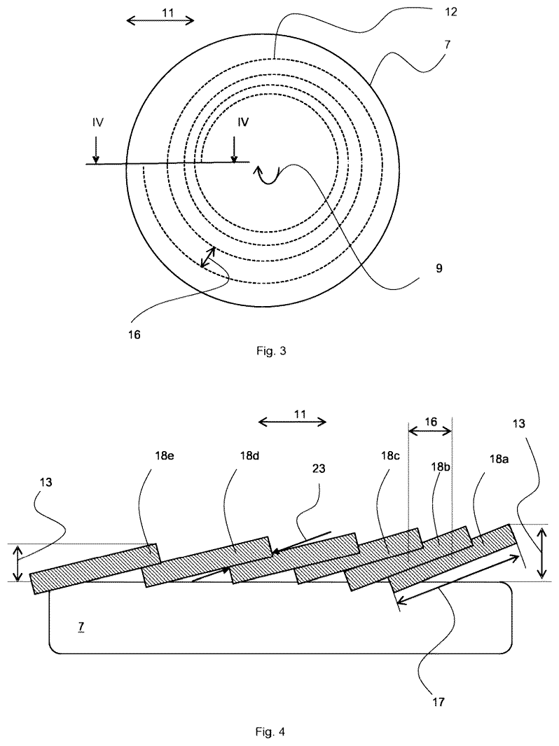

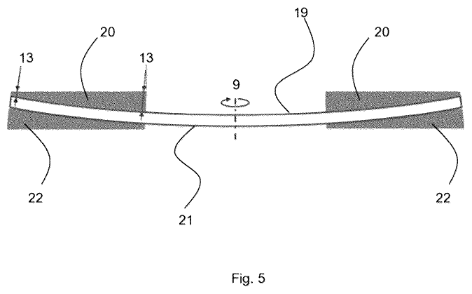

FIG. 3 shows a plan view of workpiece 7. Combining the rotational movement about the axis of rotation 9 and the translational movement along the offset direction 11 results in the spiral path 12. In the present example, the jet nozzle 3 has started to apply the powder-layer trace 6 to the workpiece 7 at the radially inner portion of the workpiece 7. The translational movement from the radially inner portion to a radially outer portion causes a trace offset of the powder-layer trace 6 along the spiral path 12. The advancing movement increases in the present example. Accordingly, an offset 16 between two adjacent spiral flanks of the spiral path 12 increases in a radially outward direction. It should be noted that the powder-layer trace 6 deposited on the workpiece 7 along the spiral path 12 has a trace width 17, such that the offset 16 does not mean a distance between two adjacent spiral flanks. Rather, adjacent spiral flanks may overlap, as is clear from the schematic sectional view along line IV-IV, as shown in FIG. 4.

FIG. 4 shows a schematic cross-section as it might result along line IV-IV of FIG. 3, to illustrate the effect of increasing translational movement as the processing progresses. A first powder-layer trace 18a is deposited on a radially inner workpiece portion. While the workpiece 7 continues to rotate, the translational movement along the offset direction 11 causes an offset 16 of a second powder-layer trace 18b relative to the first powder-layer trace 18a. The offset 16 is, for example, approximately 20% of the trace width 17, such that 80% of the second powder-layer trace 18b overlaps with the first powder-layer trace 18a to form a radial overlap 23. The translational movement increases as the processing progresses. Accordingly, the offset 16 between a third powder-layer trace 18c and the second powder-layer trace 18b is greater than that between the second powder-layer trace 18b and the first powder-layer trace 18a. The offset 16 between the second powder-layer trace 18b and the third powder-layer trace 18c is, for example, approximately 30% of the trace width 17, such that 70% of the third powder-layer trace 18c overlaps with the second powder-layer trace 18b. The radial overlap of the individual traces of the powder-layer trace 6 along the spiral path 12 decreases as the processing progresses, i.e., from the radially inner workpiece portion to the radially outer workpiece portion. As the overlap decreases, the layer thickness 13 decreases. This ensures that the layer thickness 13 decreases in a radially outward direction. The offset 16 between the radially second outermost powder-layer trace 18d and the radially outermost powder-layer trace 18e is, for example, approximately 80% of the trace width 17, such that 20% of the radially outermost powder-layer trace 18e overlaps with the radially second outermost powder-layer trace 18d. This has the following effect: laser deposition welding introduces a high amount of energy, especially thermal energy, into the workpiece 7. In a cooling phase following laser deposition welding, this leads to distortion of the workpiece 7. The distortion affects the deposited layer, which then has to be ground again so that the finished component has a flat, and therefore non-curved, surface. The material abrasion occurring during grinding is reduced because the radially outer layer thickness 13, at which the maximum distortion occurs, is less than the radially inner layer thickness 13.

FIG. 5 is a schematic representation of a workpiece 7 with a powder layer, the radially outer powder layer thickness 13 of which is less than the radially inner powder layer thickness 13 on a first workpiece side 19, in this case the top side. In this case, workpiece 7 is a brake disk. The radially outer powder layer thickness is 50 μm, for example, and the radially inner powder layer thickness is 100 μm. Layer thicknesses of between 50 μm and 500 μm are also conceivable. Due to the heat input from the weld pool 14 during laser deposition welding, internal stresses arise in the workpiece 7, in particular the brake disk, which lead to distortion of the workpiece 7 when said workpiece 7 cools down. Since the workpiece 7 takes on a shield shape due to this distortion, it is also referred to as shielding. The distortion can in principle be compensated by means of an increased layer thickness 13 on functional surfaces, i.e., the surfaces which are processed by laser deposition welding, allowing the functional surfaces of the component to be ground to be plane parallel. In FIG. 5, a first powder layer 20 has been deposited onto the first workpiece side 19 of workpiece 7 and a second powder layer 22 onto a second workpiece side 21. During laser deposition welding, the workpiece 7 has distorted, such that the first workpiece side 19 has become concave and the second workpiece side 21 convex. In accordance with this distortion, the first powder layer 20 has been deposited in such a way that a radially inner portion has a higher layer thickness 13 than a radially outer portion. During deposition of the first powder layer 20 from the radially inner portion of the workpiece 7 to the radially outer portion of the workpiece 7, the translational movement was increased as the processing progressed. Alternatively, the translational movement was reduced during deposition from the radially outer portion of the workpiece to the radially inner portion of the workpiece. The second powder layer 22 was deposited on the second workpiece side 21 in a manner complementary to this behavior of the first powder layer 20 on the first workpiece side 19. A radially inner portion of the second powder layer 22 has a smaller layer thickness 13 than a radially outer portion. During deposition of the second powder layer 22 from the radially inner portion of the workpiece 7 to the radially outer portion of the workpiece 7, the translational movement was reduced as the processing progressed. Alternatively, the translational movement was increased during deposition from the radially outer portion of workpiece 7 to the radially inner portion of workpiece 7. The first powder layer 20 and the second powder layer 22 may, for example, be deposited simultaneously. The behavior of the first powder layer 20 is complementary to that of the second powder layer 22 in terms of its powder layer thickness 13.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser system
2 Processing unit
3 Jet nozzle
4 Laser beam
5 Powder jet
6 Powder-layer trace
7 Workpiece
8 Workpiece receiving unit
9 Axis of rotation
10 Translation unit
11 Offset direction
12 Spiral path
13 Powder layer thickness
14 Weld pool
15 Interaction zone
16 Offset
17 Trace width
18a-d Various powder-layer traces
19 First workpiece side
20 First powder layer
21 Second workpiece side
22 Second powder layer
23 Radial overlap
100 Control unit
I1 Gaussian intensity profile
I2 Flat-top intensity profile
I3 Reduced core intensity profile
I4 Core intensity-free intensity profile

1. A method for laser deposition welding in a laser system, the method comprising:
actuating a processing unit having a multifunctional jet nozzle for providing a laser beam and a powder jet, so that the powder jet, in interaction with the laser beam, deposits a powder-layer trace onto a workpiece;
actuating a workpiece receiving unit, on which the workpiece is arranged, so that a rotational movement moves the workpiece about an axis of rotation; and
actuating a translation unit, so that a translational movement moves the jet nozzle and/or the workpiece receiving unit in an offset direction substantially orthogonal to the axis of rotation;
wherein the rotational movement and the translational movement combine to form an advancing movement such that the powder-layer trace is deposited onto the workpiece along a spiral path, and
wherein a processing parameter varies as processing of the workpiece progresses, so that a powder layer thickness varies along a radial direction of the workpiece.

2. The method as claimed in claim 1, wherein
the processing parameter is the advancing movement, a powder mass flow of the powder jet, or a laser power of the laser beam.

3. The method as claimed in claim 2, wherein
the powder-layer trace has a radial trace width, wherein an offset of two adjacent spiral flanks of the spiral path is less than the radial trace width, such that the powder-layer trace forms a radial overlap along the spiral path.

4. The method as claimed in claim 3, wherein the radial overlap varies proportionally to the varying advancing movement.

5. The method as claimed in claim 3, wherein
a rate of the advancing movement increases during processing of a first workpiece side from a radially inner workpiece portion to a radially outer workpiece portion as the processing progresses, such that the radial overlap of the spiral path at the radially outer portion is less than at the radially inner portion, or
a rate of advancing movement decreases during processing of a first workpiece side from a radially outer workpiece portion to a radially inner workpiece portion as the processing progresses, such that the radial overlap of the spiral path at the radially outer portion is less than at the radially inner portion.

6. The method as claimed in claim 5, wherein
the rate of advancing movement decreases during processing of a second workpiece side from a radially inner workpiece portion to a radially outer workpiece portion as the processing progresses, such that the radial overlap of the spiral path at the radially outer portion is greater than at the radially inner portion, or
the rate of advancing movement increases during processing of a second workpiece side from a radially outer workpiece portion to a radially inner workpiece portion as the processing progresses, such that the radial overlap of the spiral path at the radially outer portion is greater than at the radially inner portion.

7. The method as claimed in claim 5, wherein
based on a distortion that occurs in the workpiece during the laser deposition welding, it is determined whether a workpiece side is processed as the first workpiece side or as the second workpiece side.

8. The method as claimed in claim 3, wherein
the radial overlap of the powder-layer trace at a first radial end portion amounts to above 50% of the radial trace width, and the radial overlap at a second radial end portion amounts to below 50% of the radial trace width.

9. The method as claimed in claim 3, wherein
the radial overlap of the powder-layer trace at a first radial end portion results in a first layer thickness, and the radial overlap at a second radial end portion results in a second layer thickness, wherein the first layer thickness exceeds the second layer thickness by a factor of 1.5 or more.

10. The method as claimed in claim 1, wherein
the varying processing parameter is preset in response to previously processed workpieces.

11. The method as claimed in claim 3, wherein
the rotational movement is constant, such that the varying advancing movement results exclusively from a varying translational movement.

12. The method as claimed in claim 1, wherein
the workpiece is arranged fixed in the offset direction, such that the translational movement results from movement of the jet nozzle.

13. The method as claimed in claim 1, wherein
the powder-layer trace forms an adhesive layer onto which an abrasion-resistant layer is deposited in a next step.

14. A control unit for use in a laser system for laser deposition welding, wherein the control unit is configured to carry out the method as claimed in claim 1.

15. A laser system for laser deposition welding, the laser system comprising:
a processing unit having a multifunctional jet nozzle for providing a laser beam and a powder jet;
a workpiece receiving unit, on which a workpiece is arranged;
a translation unit configured to move the jet nozzle and/or the workpiece receiving unit in an offset direction substantially orthogonal to an axis of rotation; and
a control unit as claimed in claim 14.
